(19) United States
(12) Patent Application Publication
(10) Pub. No.: US 2016/0110658 A1
(43) Pub. Date: Apr. 21, 2016

(54) IMAGE FORMING SYSTEM AND IMAGE FORMING APPARATUS

(71) Applicant: KYOCERA Document Solutions Inc.

(72) Inventor: Masaki Sanou, Osaka (JP)

(73) Assignee: Kyocera Document Solutions

(21) Appl. No.: 14/867,643

(22) Filed: Sep. 28, 2015

(30) Foreign Application Priority Data
Oct. 20, 2014 (JP) 2014-213859

(51) Int. Cl. G06Q 10/02; H04N 1/203; G06F 3/12; H04N 1/00

(52) U.S. Cl. CPC G06Q 10/02; H04N 1/00244; H04N 1/00344; H04N 1/00392; H04N 1/203; G06F 3/1294; G06F 3/128; G06F 3/1287; H04N 2201/0094

(57) ABSTRACT

In an image forming apparatus, a cooperation processing unit performs a cooperation process according to an instruction from the travel expense reporting application of a terminal apparatus. The travel expense reporting application communicates with a travel expense reporting system that receives an electronic applying of a travel expense report. The cooperation processing unit (a) reads usage history data of public transportation from an IC card in accordance with an instruction received from the travel expense reporting application and transmits the usage history data to the travel expense reporting application, (b) scans an image of the original of a receipt in accordance with an instruction received from the travel expense reporting application, and (c) prints a document for a paper applying of a travel expense report that includes (c1) a usage history to be reported and (c2) the image of the original of the receipt.

### CROSS-REFERENCE TO RELATED APPLICATIONS

This application relates to and claims priority rights from Japanese Patent Applications No. 2014-213859, filed on Oct. 20, 2014, the entire disclosures of which are hereby incorporated by reference herein.

### BACKGROUND

1. Field of the Present Disclosure

The present disclosure relates to an image forming system and an image forming apparatus.

2. Description of the Related Art

In a system, an image forming apparatus reads a usage history of a bus or a railroad from an IC card, and electronically transmits a travel expense report applying to a server.

A company obligates to attach the original of a receipt in a travel expense report applying except for a fare of local public transportation, and therefore in some cases requires both of a written applying (i.e. paper applying) and the aforementioned electronic applying.

For example, it is obligated to store the original of a receipt for a predetermined money amount, for example, 30,000 Japanese Yen or more, and therefore, a travel expense report applying including such money amount is sometimes submitted as a paper applying for submitting the original of a receipt in addition to an electronic applying.

In a case that both of a paper applying and an electronic applying are required, a user can perform an electronic applying using the aforementioned system on the basis of information read from the IC card, but the user must manually make a document for a paper applying separately from an electronic applying.

### SUMMARY

An image forming system according to an aspect of the present disclosure includes a terminal apparatus and an image forming apparatus. The terminal apparatus comprises a travel expense reporting application configured to communicate with a travel expense reporting system that receives an electronic applying of a travel expense report. The image forming apparatus comprises an image scanning device, a printing device, an IC card reader, and a cooperation processing unit configured to perform a cooperation process according to an instruction from the travel expense reporting application. The cooperation processing unit (a) reads usage history data of public transportation from an IC card using the IC card reader in accordance with an instruction received from the travel expense reporting application and transmits the usage history data to the travel expense reporting application, (b) scans an image of an original of a receipt using the image scanning device in accordance with an instruction received from the travel expense reporting application, and (c) prints a document for a paper applying of a travel expense report that includes (c1) a usage history to be reported on the basis of the usage history data and (c2) the image of the original of the receipt using the printing device. The travel expense reporting application (d) receives the usage history data transmitted from the cooperation processing unit, and (e) performs an electronic applying of the travel expense report for the usage history to be reported on the basis of the usage history data.

An image forming apparatus according to an aspect of the present disclosure includes a communication device; an image scanning device; a printing device; an IC card reader; and a cooperation processing unit. The communication device is capable of communicating with a terminal apparatus that includes a travel expense reporting application. The travel expense reporting application communicates with a travel expense reporting system that receives an electronic applying of a travel expense report. The cooperation processing unit is configured to perform a cooperation process according to an instruction from the travel expense reporting application. The cooperation processing unit (a) reads usage history data of public transportation from an IC card using the IC card reader in accordance with an instruction received from the travel expense reporting application and transmits the usage history data to the travel expense reporting application using the communication device, (b) scans an image of an original of a receipt using the image scanning device in accordance with an instruction received from the travel expense reporting application, and (c) prints a document for a paper applying of a travel expense report that includes (c1) a usage history to be reported on the basis of the usage history data and (c2) the image of the original of the receipt using the printing device.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image forming system in an embodiment of the present disclosure;

FIG. 2 shows a diagram that indicates an example of report sheets for a paper applying that are duplex printed by the image forming apparatus shown in FIG. 1; and

FIG. 3 shows a sequence diagram that explains a behavior of apparatuses in the image forming system shown in FIG. 1.

### DETAILED DESCRIPTION

Hereinafter, an embodiment according to aspects of the present disclose will be explained with reference to drawings.

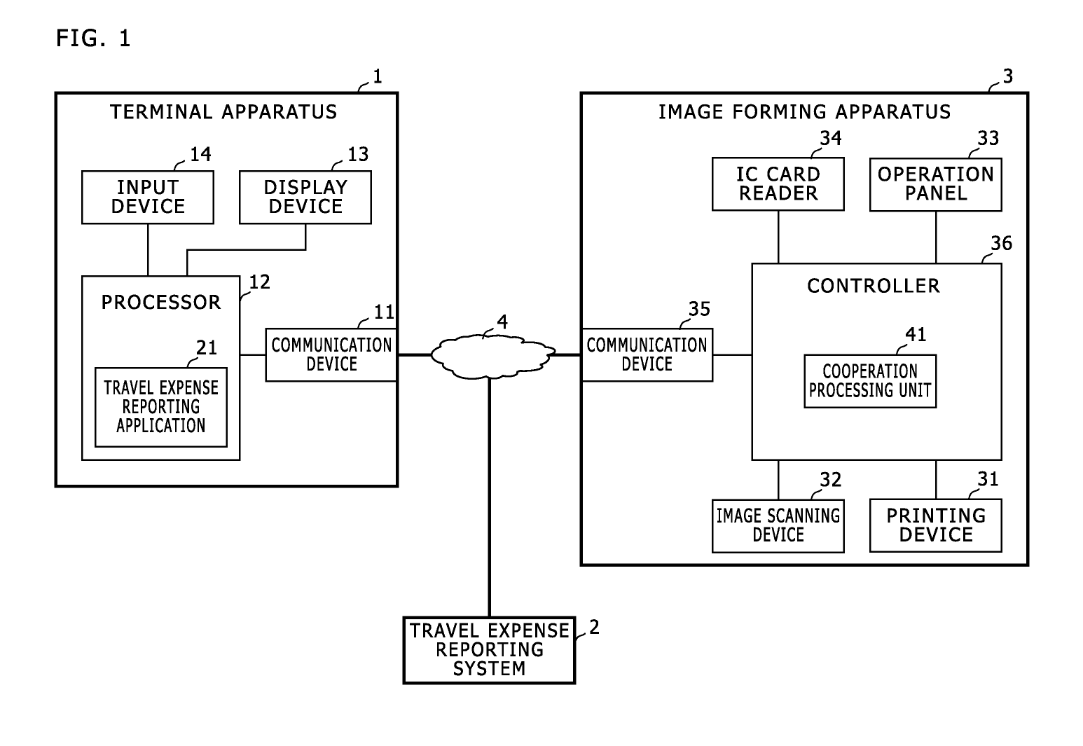

FIG. 1 shows a block diagram that indicates a configuration of an image forming system in an embodiment of the present disclosure. In the system shown in FIG. 1, a terminal apparatus 1 of a user includes a travel expense reporting application 21 that communicates with a travel expense reporting system 2. The travel expense reporting system 2 receives and processes an electronic applying of a travel expense report. An image forming apparatus 3 performs sorts of processes for a travel expense report applying in accordance with an instruction received from the travel expense reporting application 21. For example, the image forming apparatus 3 is a multi function peripheral. The travel expense reporting system 2 is connected to a network 4 and receives an electronic applying of a travel expense report from the travel expense reporting application 21 using an unshown server.

The terminal apparatus 1 is a mobile terminal device, a desktop personal computer or the like, and includes a communication device 11, a processor 12, a display device 13, and an input device 14.

The communication device 11 is a network interface or the like and is capable of communicating with the travel expense reporting system 2 and the image forming apparatus 3. The processor 12 includes a CPU (Central Processing Unit), a RAM (Random Access Memory), a ROM (Read Only Memory), and the like, loads a program from the ROM or an unshown non volatile storage device to the RAM, and executes the program using the CPU, and thereby acts as the travel expense reporting application 21. The display device 13 is a liquid crystal display or the like and displays an operation screen and the like for a user. The input device 14 includes a touch panel, a hard key or the like, and receives a user operation.

The travel expense reporting application 21 (a) transmits an instruction to the image forming apparatus 3 for reading out usage history data from a user's IC card and receives the usage history data transmitted from the cooperation processing unit 41, and (b) performs an electronic applying of the travel expense report to the travel expense reporting system 2 using the communication device 11 for the usage history to be reported on the basis of the received usage history data.

The image forming apparatus 3 includes a printing device 31, an image scanning device 32, an operation panel 33, an IC card reader 34, a communication device 35, and a controller 36.

The printing device 31 is an internal device that prints each page image based on print image data on a paper sheet using electrophotography.

The image scanning device 32 is an internal device that optically scans a document image of a document and generates image data of the document image.

The operation panel 33 is arranged on a surface of a housing of the image forming apparatus 3, and includes a display device that displays sorts of information to a user and an input device that detects a user operation. For example, a liquid crystal display is used as the display device. A key switch, a touch panel or the like is used as the input device.

The IC card reader 34 reads data from an IC card that can be used as a public transportation ticket (e.g. a FeliCa (registered trademark) type IC card). The IC card reader 34 may be built in the image forming apparatus 3 or may be connected to the image forming apparatus 3.

The communication device 35 is an electronic circuit connected to the network 4 such as a wired LAN or the like, and performs data communication with another apparatus (e.g. the terminal apparatus 1) connected to the network 4.

Further, the controller 36 includes a computer, ASIC (Application Specific Integrated Circuit) and/or the like, and controls internal devices of the image forming apparatus 3. The controller 36 acts as a cooperation processing unit 41.

The cooperation processing unit 41 (a) reads usage history data of public transportation from a user's IC card using the IC card reader 34 in accordance with an instruction received from the travel expense reporting application 21 and transmits the usage history data to the travel expense reporting application 21 using the communication device 35, (b) scans an image of an original of a receipt using the image scanning device 32 in accordance with an instruction received from the travel expense reporting application 21, (c) prints a document for a paper applying of a travel expense report that includes (c1) a usage history to be reported on the basis of the usage history data and (c2) the image of the original of the receipt using the printing device 31.

In this embodiment, in accordance with a user operation, the travel expense application 21 selects a usage history record to be reported among all usage history records obtained from the usage history data, and informs the selected usage history record to be reported to the cooperation processing unit 41. The cooperation processing unit 41 receives the usage history record to be reported transmitted from the travel expense application 21, and prints a document for a paper applying of a travel expense report. This document includes the received usage history and the image of the original of a receipt (i.e. a receipt of travel expenses). Therefore, a user can make the document for a paper applying that excludes a usage history record not to be reported.

Further, in this embodiment, the document for the paper applying includes a mount paper sheet on which the original of the receipt is stuck. The cooperation processing unit 41 prints the image of the original of the receipt on the mount paper sheet for indicating a sticking position of the original of the receipt.

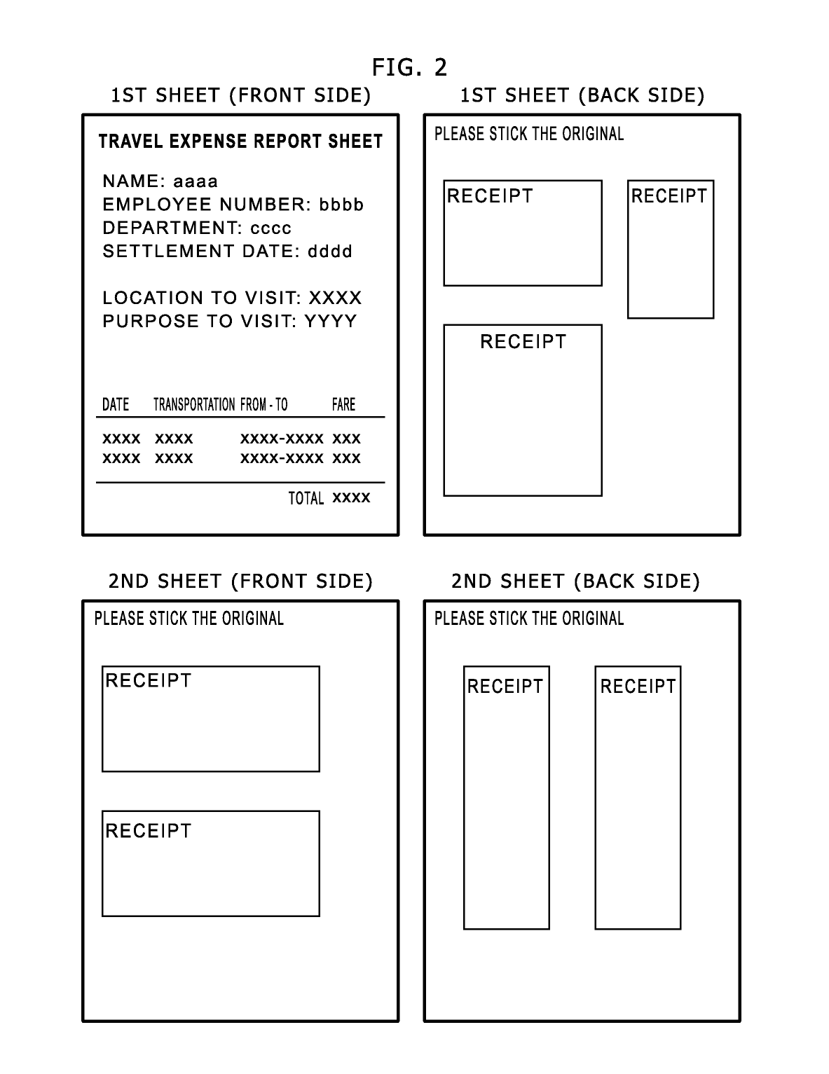

FIG. 2 shows a diagram that indicates an example of report sheets for a paper applying that are duplex printed by the image forming apparatus shown in FIG. 1. For example, as shown in FIG. 2, on the front side of the first sheet among the report sheets, printed are user information (user name, department name and the like), visit information (name of the visited location, purpose and the like), and the usage history (date, transportation name, travel path, fare and the like). The back side of the first sheet is assigned as a mount paper sheet on which the original of a receipt should be stuck, and on the back side of the first sheet, the image of the receipt scanned by the image scanning device 32 is printed, for example, with an actual size of the receipt. The arrangement positions of the images of the receipts are automatically determined on the basis of the scanning order of the images, the sizes of the images and the like. If all of the images can not be assigned to the back side of the first sheet, then as shown in FIG. 2, the second sheet of the report sheets is printed, on which in the order from the front side to the back side of the second sheet, subsequent images of the receipts are printed. In such a manner, such sheets are printed for the number of mount paper sheets required to stick the originals of receipts.

Further, in this embodiment, the cooperation processing unit 41 receives manually inputted travel expense information from the travel expense reporting application 21 using the communication device 35 and prints the document for the paper applying that includes (c1) the usage history to be reported, (c2) the image of the original of the receipt and (c3) the manually inputted travel expense information using the printing device 31. Here, the manually inputted travel expense information is manually inputted to the travel expense reporting application 21 by a user. Therefore, in the document for the paper applying, a user can manually include travel expenses that the user spent without the IC card.

For example, in case of a large transportation expense, a user often purchases a ticket or the like in advance without the IC card, and therefore often manually inputs travel expense information (date, transportation name, travel path, fare and the like) in the aforementioned manner.

It should be noted that the travel expenses include a lodging expense for a hotel or the like, and a user often pays such lodging expense without the IC card and therefore often manually inputs travel expense information (date, lodging name, lodging expense and the like) in the aforementioned manner.

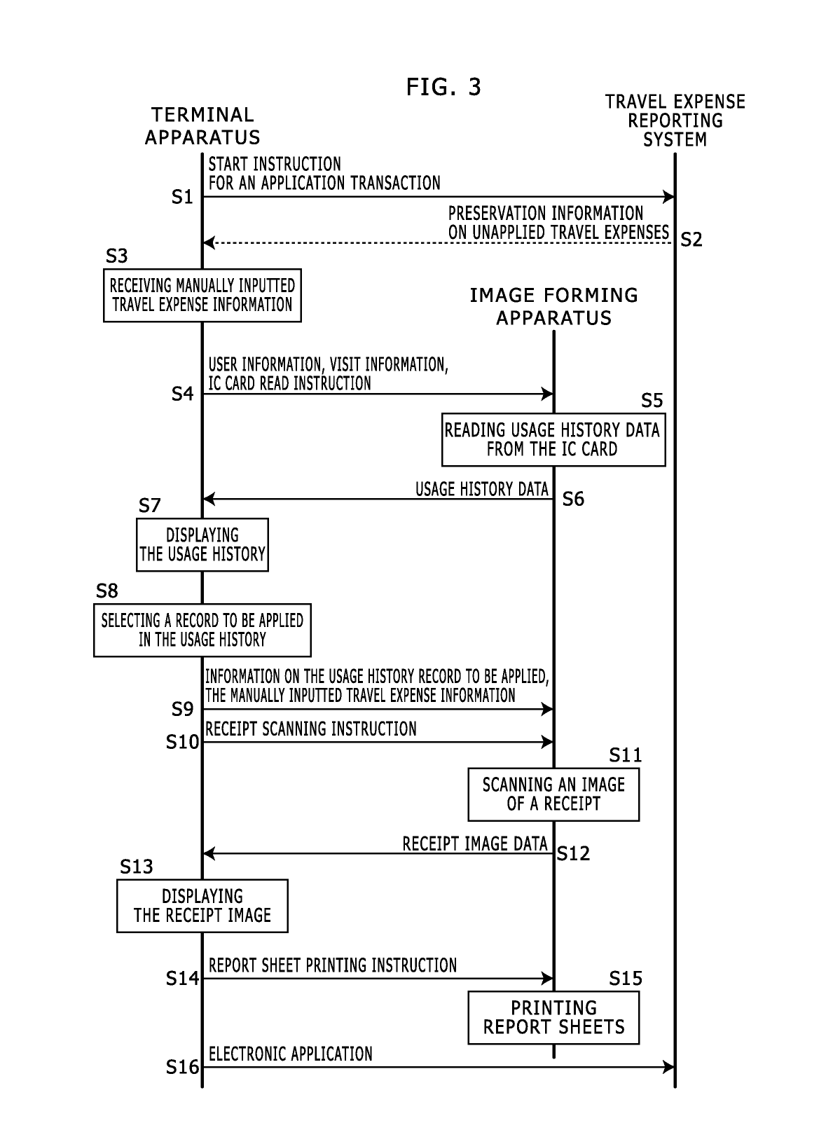

The following part explains a behavior of apparatuses in the image forming system shown in FIG. 1. FIG. 3 shows a sequence diagram that explains a behavior of apparatuses in the image forming system shown in FIG. 1.

Firstly, the travel expense reporting application 21 generates new applying form data in a predetermined format specified by a company or the like in accordance with a user operation to the input device 14, and transmits a start instruction for an applying transaction to the travel expense reporting system 2 using the communication device 11 (in Step S1).

At this timing, if the travel expense reporting system preserves preservation information on unapplied travel expenses, then the travel expense reporting system 2 transmits the preservation information to the travel expense reporting application 21 (in Step S2). Once receiving the preservation information on unapplied travel expenses, the travel expense reporting application 21 restarts a process for a travel expense report applying of the unapplied travel expenses. It should be noted that the preservation information on unapplied travel expenses is manually inputted travel expense information that was transmitted to the travel expense reporting system 2 when a process for a travel expense report applying was suspended after inputting the manually inputted travel expense information.

Subsequently, the travel expense reporting application receives manually inputted travel expense information (information on transportation expenses and/or lodging expenses) inputted to the input device 14 by the user (in Step S3). Here the user inputs information on travel expenses that the user paid without the IC card.

Further, the travel expense reporting application 21 transmits the user information and the visit information to the image forming apparatus 3 using the communication device 11, and transmits an IC card read instruction to the image forming apparatus 3 (in Step S4). The user information was registered to the travel expense reporting application 21 in advance, for example, when installing the travel expense reporting application 21. The visit information was inputted to the terminal apparatus 1 by the user, for example, when newly generating the applying form data. In the image forming apparatus 3, once receiving the IC card read instruction using the communication device 35, the cooperation processing unit 41 reads usage history data from the IC card using the IC card reader 34 (in Step S5). At this timing, the user brings a specific IC card near the IC card reader 34, and this IC card is used as a ticket of a public transportation by the user. Once detecting the approaching IC card, the IC card reader 34 reads usage history data from the IC card.

Subsequently, the cooperation processing unit 41 transmits the usage history data read from the user's IC card to the travel expense reporting application 21 using the communication device 35 (in Step S6).

In the terminal apparatus 1, once receiving the usage history data using the communication device 11, the travel expense reporting application 21 displays (a) all usage history records obtained from the received usage history data and (b) the manually inputted travel expense information on the display device 13 (in Step S7).

The user operates the input device 14 and thereby, selects a usage history record and a piece of the manually inputted travel expense information to be reported among the displayed usage history records and the displayed manually inputted travel expense information. The travel expense reporting application 21 identifies the usage history record and the piece of the manually inputted travel expense information selected by the user (in Step S8), and informs the identified usage history record to the cooperation processing unit 41 of the image forming apparatus 3 and transmits the selected manually inputted travel expense information to the cooperation processing unit 41 of the image forming apparatus 3 (in Step S9). Regarding to the manually inputted travel expense information, the whole part of the inputted may be transmitted to the cooperation processing unit 41 without selecting a piece to be transmitted.

Further, the travel expense reporting application 21 transmits a receipt scanning instruction to the image forming apparatus 3 using the communication device 11 (in Step S10). In the image forming apparatus 3, once receiving the receipt scanning instruction using the communication device 35, the cooperation processing unit 41 scans an image of the original of a receipt of the travel expense using the image scanning device 32, and thereby generates image data of the receipt (in Step S11). For this process, the user put the receipt (e.g. a receipt of a public transportation) on the image scanning device 32 in advance.

In this process, if a user puts plural receipts on the image scanning device 32, then the image scanning device 32 scans the plural receipts at once and thereby generates a scanning image (i.e. a page image) that includes plural images of the receipts and the cooperation processing unit 41 may extracts the respective plural images of the receipts from the scanning image. Alternatively, the plural images of the receipts may be scanned one by one in continuous plural times of image scanning.

Subsequently, the cooperation processing unit 41 transmits the aforementioned receipt image data to the travel expense reporting application 21 using the communication device 35 (in Step S12).

In the terminal apparatus 1, once receiving the receipt image data using the communication device 11, the travel expense reporting application 21 displays the image of the receipt based on the receipt image data on the display device 13 (in Step S13).

After confirming the displayed image of the receipt, the user performs an operation to the terminal apparatus 1 in order to print a report sheet for the paper applying. Once receiving this user operation, the travel expense reporting application 21 transmits a report sheet printing instruction to the image forming apparatus 3 (in Step S14). In the image forming apparatus 3, once receiving the report sheet printing instruction using the communication device 35, the cooperation processing unit 41 prints a report sheet that includes (a) the aforementioned usage history record and the aforementioned manually inputted travel expense information to be reported in the applying and (b) the aforementioned image of the receipt, for example as shown in FIG. 2, using the printing device 31 (in Step S15).

Further, the travel expense reporting application 21 in the terminal apparatus 1 inserts the aforementioned usage history record and the aforementioned manually inputted travel expense information to be reported in the application into the applying form data and thereby generates data required for the electronic applying, and performs the electronic applying to the travel expense reporting system 2 for the aforementioned usage history record and the aforementioned manually inputted travel expense information to be reported (in Step S16). Thus, the electronic applying transmits to the travel expense reporting system 2 the applying form data into which the usage history record and the manually inputted travel expense information to be reported were inserted.

In the aforementioned embodiment, the cooperation processing unit 41 of the image forming apparatus 3 (a) reads usage history data of public transportation from a user's IC card using the IC card reader 34 in accordance with an instruction received from the travel expense reporting application 21 and transmits the usage history data to the travel expense reporting application 21 using the communication device 35, (b) scans an image of the original of a receipt using the image scanning device 32 in accordance with an instruction received from the travel expense reporting application 21, and (c) prints a document for a paper applying of a travel expense report that includes (c1) a usage history to be reported on the basis of the usage history data and (c2) the image of the original of the receipt using the printing device 31.

Therefore, when a user performs the electronic applying to the travel expense reporting system 2 on the basis of a usage history of the user's IC card using the IC card reader 34 of the image forming apparatus 3, a report sheet required for the paper applying is printed in conjunction with the electronic applying. Consequently, when both of a paper applying and an electronic applying are required, the user can perform the electronic applying and making a document for the paper applying by easy operations.

The description has been presented for purposes of illustration and description, and is not intended to be exhaustive or limited.

For example, in the aforementioned embodiment, when displaying (a) all usage history records obtained from the received usage history data and (b) the manually inputted travel expense information on the display device 13, the travel expense reporting application 21 may display a message (marker, text or the like) together with the usage history record or the piece of the manually inputted travel expense information with a money amount equal to or more than the lower most money amount that requires storage obligation of the original of a receipt, and the message may indicate that the attachment of the original of a receipt is required.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming system, comprising:
a terminal apparatus that comprises a travel expense reporting application configured to communicate with a travel expense reporting system that receives an electronic applying of a travel expense report; and
an image forming apparatus that comprises an image scanning device, a printing device, an IC card reader, and a cooperation processing unit configured to perform a cooperation process according to an instruction from the travel expense reporting application;
wherein the cooperation processing unit (a) reads usage history data of public transportation from an IC card using the IC card reader in accordance with an instruction received from the travel expense reporting application and transmits the usage history data to the travel expense reporting application, (b) scans an image of an original of a receipt using the image scanning device in accordance with an instruction received from the travel expense reporting application, and (c) prints a document for a paper applying of a travel expense report that includes (c1) a usage history to be reported on the basis of the usage history data and (c2) the image of the original of the receipt using the printing device; and
the travel expense reporting application (d) receives the usage history data transmitted from the cooperation processing unit, and (e) performs an electronic applying of the travel expense report for the usage history to be reported on the basis of the usage history data.

2. An image forming apparatus, comprising:
a communication device capable of communicating with a terminal apparatus that includes a travel expense reporting application, the travel expense reporting application communicating with a travel expense reporting system that receives an electronic applying of a travel expense report;
an image scanning device;
a printing device;
an IC card reader; and
a cooperation processing unit configured to perform a cooperation process according to an instruction from the travel expense reporting application;
wherein the cooperation processing unit (a) reads usage history data of public transportation from an IC card using the IC card reader in accordance with an instruction received from the travel expense reporting application and transmits the usage history data to the travel expense reporting application using the communication device, (b) scans an image of an original of a receipt using the image scanning device in accordance with an instruction received from the travel expense reporting application, and (c) prints a document for a paper applying of a travel expense report that includes (c1) a usage history to be reported on the basis of the usage history data and (c2) the image of the original of the receipt using the printing device.

3. The image forming apparatus according to claim 2, wherein:
the usage history to be reported is selected from the usage history data by the travel expense reporting application in the terminal apparatus; and
the cooperation processing unit transmits the usage history data to the terminal apparatus using the communication device, and from the travel expense reporting application, receives the usage history to be reported.

4. The image forming apparatus according to claim 2, wherein:
the document for the paper applying includes a mount paper sheet on which the original of the receipt is stuck; and
the cooperation processing unit prints the image of the original of the receipt on the mount paper sheet for indicating a sticking position of the original of the receipt.

5. The image forming apparatus according to claim 2, wherein the cooperation processing unit receives manually inputted travel expense information from the travel expense reporting application using the communication device, the manually inputted travel expense information manually inputted to the travel expense reporting application by a user; and prints the document for the paper applying that includes (c1) the usage history to be reported, (c2) the image of the original of the receipt and (c3) the manually inputted travel expense information using the printing device.
